(19) United States
(12) Patent Application Publication
(10) Pub. No.: US 2007/0149900 A1
(43) Pub. Date: Jun. 28, 2007

(54) Light guide comb

(76) Inventor: Che-Wen Lin, Junghe City (TW)

Correspondence Address: Che-Wen Lin, P.O. Box No. 6-57, Junghe, Taipei, 235, TW

(21) Appl. No.: 11/635,536

(22) Filed: Dec. 8, 2006

(30) Foreign Application Priority Data
Dec. 12, 2005 (CN) 200510102242.2

(51) Int. Cl. A61H 1/00; A61H 7/00

(52) U.S. Cl. 601/15; 601/136; 601/137

(57) ABSTRACT

A light guide comb that produces a direct massage effect on the head of a user, and, moreover, uses light rays to promote cell activation of the head, cortical layer and acupuncture points, while simultaneously stimulating hair follicles to promote the health and growth of hair. The light guide comb includes an upper shell, a lower shell, a compartment, a light stimulation device and a light guide. A plurality of guide holes are defined in the upper shell to correspond to a plurality of guide pins configured on the light guide. Light rays produced by the light stimulation device disposed within the compartment are propagated through the plurality of guide pins and transmitted outward. A plurality of massage knobs are disposed on a comb head of the lower shell to provide a massage surface area greater than that of the plurality of guide pins.

### BACKGROUND OF THE INVENTION

(a) Field of the Invention

A light guide comb that particularly provides a comb that is able to part the hair during the course of combing and produce a massage effect directly on the head of the user, and which uses light rays to promote activation of scalp cells and stimulate the hair follicles to encourage the health and growth of hair.

(b) Description of the Prior Art

Because of the many pressures on modern people that cause life stress or headaches, insomnia, memory loss or neurosis brought about by improper diet, and so on, resulting in acquired alopecia that causes hair follicle atrophy and hair loss or hair follicle necrosis resulting in baldness. And consequent effects of baldness can not only cause possible discord in the family and interpersonal relationships from psychosomatic imbalance, there is even the greater possibility of an inferiority complex from hair loss and baldness that affects work.

Apart from the use of drugs to treat headaches, insomnia, memory loss, neurosis, and so on, or hair loss and baldness brought about by many pressures, recent years have advocated the use of massage or light wave stimulation to treat such afflictions. Moreover, research has demonstrated that rays having wavelength equal to that of infrared light or far-infrared rays can affect catalysis of hair follicle cell structure that produces a resuscitating effect. Such wavelengths are primarily used to synchronously stimulate the hair follicle cells to produce wave motions of similar frequency to affect a catalysis function that achieves cell activation and stimulation of hair growth. Conventional phototherapy apparatus on the current market are primarily designed for use on body parts of the user other than the head, and are only reluctantly used on the head whereby a light source producing specific light waves is allowed to penetrate parted hair and irradiate the scalp. However, light wave interference caused by the hair obstructing the light or the light being reflected from grease affects the light wave structure, resulting in the scalp only receiving a portion of the light energy, whereas most of the light energy is absorbed by the hair, causing damage thereto. Hence, when operating the phototherapy apparatus, a comb must be used to part the hair in order to expose a small area of the scalp to the irradiating light waves, which results in the phototherapy apparatus being inconvenient and tedious to operate. Moreover, conventional phototherapy apparatus are unable to achieve the anticipated phototherapy effect.

### SUMMARY OF THE INVENTION

A primary objective of the present invention is to provide a light guide comb that achieves a comprehensive vibration wave effect that promotes hair follicle activation and stimulates luxuriant growth of hair. In order to achieve this objective, the present invention primarily comprises an upper shell, a lower shell and a compartment formed from the upper shell and the lower shell, a light stimulation device and a light guide. A plurality of guide holes are defined in the upper shell to correspond to a plurality of guide pins configured on the light guide. The plurality of guide pins part the hair when combing with the light guide comb, and light rays produced by the light stimulation device disposed within the compartment are transmitted to ends of each of the guide pins, and are able to directly act on the scalp of a user to produce a massage effect. During the course of combing the hair, the light rays transmitted by the guide pins directly irradiate the scalp to achieve the comprehensive vibration wave effect that promotes hair follicle activation and stimulates luxuriant growth of hair.

A second objective of the present invention is to provide the light guide comb with a structural assembly wherein optical fibers are connected to comb teeth. Light rays emitted by a light generator are received and transmitted through a coupling end that gathers together the optical fibers. The comb teeth are supported on a base, and an interior of each of the comb teeth forms a passageway that enables the optical fibers to be axially disposed therein.

A third objective of the present invention is to provide the light guide comb with at least more than one massage knob disposed on an outer portion of a comb head of the lower shell, which provides an extended massage surface area. The massage knobs are fabricated from different material or formed in different shapes to enable the user to replace the massage knobs 8 according to different needs or preferences.

A fourth objective of the present invention is to provide the light guide comb with at least more than one massage knob disposed on the outer portion of the comb head of the lower shell, which provides an extended massage surface area. The massage knobs can be provided with light guides to enable the transmittance of light rays.

A fifth objective of the present invention is to further provide the light guide comb with a vibration wave device having vibrational energy disposed within the comb head and the compartment of a handle. During the course of combing the hair and massaging the head, the vibration wave device can simultaneously assist the light rays in producing mechanical massage stimulation of the scalp to achieve a synergistic root effect.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an exploded elevational view according to the present invention.

FIG. 2 shows a schematic elevational view depicting structural assembly of an upper shell according to the present invention.

FIG. 3 shows a schematic elevational view depicting structural assembly of a lower shell according to the present invention.

FIG. 4 shows a schematic view depicting intersecting relationship of points of light according to the present invention.

FIG. 5 shows a schematic view depicting comb teeth pressing on the scalp according to the present invention.

FIG. 5A shows a partially enlarged view of depicting comb teeth pressing on the scalp according to the present invention.

FIG. 6 shows a side cutaway view of another embodiment according to the present invention.

FIG. 7 shows a partial cutaway view of FIG. 6 depicting structural connecting of the comb teeth with optical fibers according to the present invention.

FIG. 8 shows a cutaway view of the present invention in use on the scalp.

### DETAILED DESCRIPTION OF THE PREFERRED EMBODIMENTS

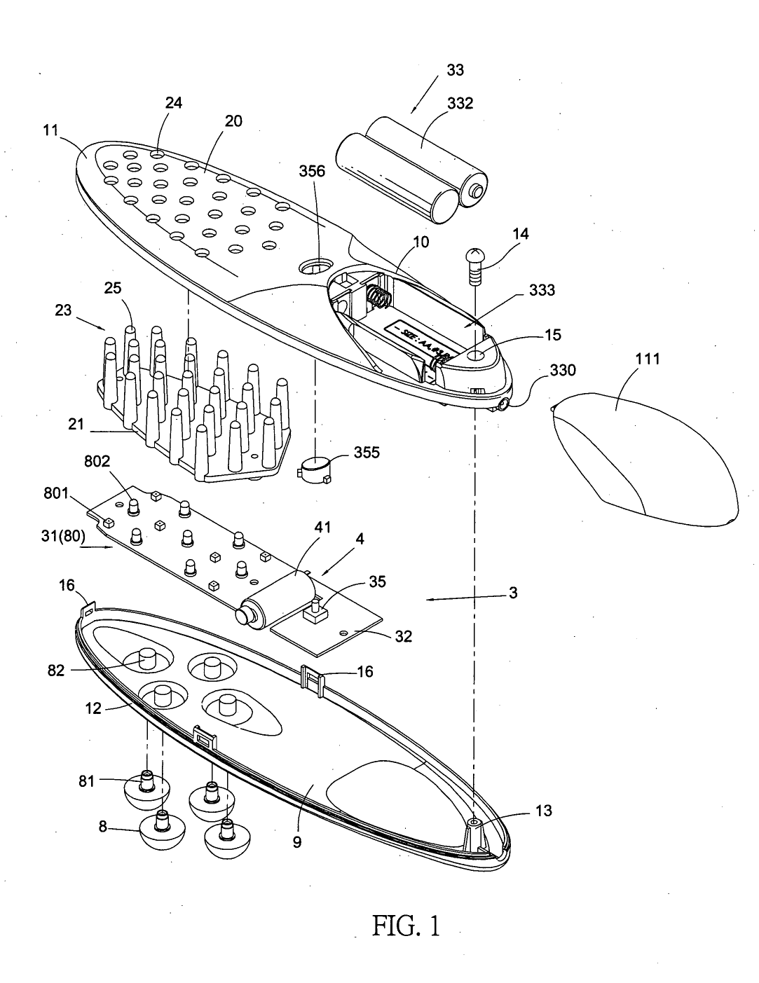

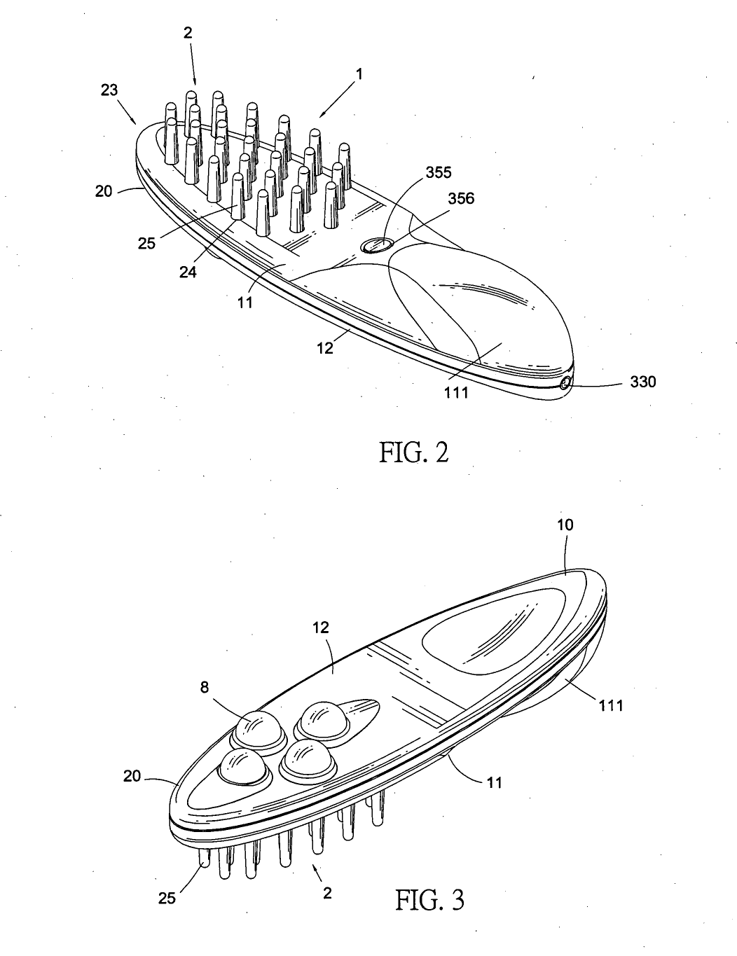

Referring to FIGS. 1 and 2, which shows a comb 1 of the present invention comprising a plurality of comb teeth 2, an upper shell 11, a lower shell 12, a compartment 9, a light stimulation device 3 and a light guide 23, wherein the upper shell 11 and the lower shell 12 are mutually joined to form the compartment 9 that enables the light stimulation device 3 to be disposed therein. The comb teeth 2 are also defined as a plurality of guide pins 25. A plurality of guide holes 24 are defined in the upper shell 11, position of which are such to correspond to the plurality of guide pins 25 configured on the light guide 23. The plurality of guide pins 25 penetrate the plurality of guide holes 24, thereby mutually joining the two together. Light rays emitted by the light stimulation device 3 configured within the compartment 9 penetrate the plurality of guide holes 24 through the guide pins 25 and are transmitted outwardly therefrom, the hair of the user is thus prevented from obstructing the light rays, and enables the emitted light rays to directly irradiate, contact and massage the head of the user. Moreover, the plurality of guide pins 25 have the function to comb the hair.

The aforementioned plurality of guide pins 25 are regulated on a base 21 that is disposed within the compartment 9 so that the plurality of guide pins 25 are positioned in an acting face of a comb head 20. The light stimulation device 3 disposed within the compartment 9 comprises a light generator 31, a drive circuit 32, a power supply device 333 and a switch 35. Electricity is provided by the power supply device 333 after regulating and controlling the light generator 31 using the drive circuit 32 and the switch 35. The power supply device 333 includes direct current or alternating current, and electric sources 33 disposed within an embodiment of the power supply device enable the emitting of light. The internally disposed electric sources 33 can be connected to an external power supply connector by means of an electrical outlet 330 to supply electricity thereto (not shown in the drawings). Moreover, the light waves emitted can be controlled to produce low power light ray wavelengths.

The light rays emitted by the light generator 31 can be further modulated using the drive circuit 32 to produce pulse light or far-infrared rays that are able to stimulate and activate cells and hair follicle structure to achieve a resuscitation and rejuvenation function. An embodiment of the light generator 31 is a diode light emitter 80. Because far-infrared rays are invisible light, thus, the user is unable to identify them with the naked eye, and in order for the light guide 23 of the comb 1 of the present invention to be able to produce a light-emitting visual effect, the diode light emitter 80 comprises not only far-infrared ray light-emitting diodes 801, but is also further configured with colored light-emitting diodes. An embodiment of the present invention uses red light-emitting diodes 802 to transmit red light through the light guide 23.

A vibration wave device 4 is further disposed in the compartment 9 in the position of the comb head 20. And an embodiment of the vibration wave device 4 is a motor 41.

Because the light guide 23 is fabricated from transparent material, thus, it is able to transmit the light rays emitted by the far-infrared ray light-emitting diodes 801 and the red light-emitting diode 802, and more particularly the plurality of guide pins 25 configured on the light guide 23 and regulated on the base 21 penetrate the upper shell 11, thereby securing the configuration and providing the comb 1 with advantages of a stable structure and easy manual assembly.

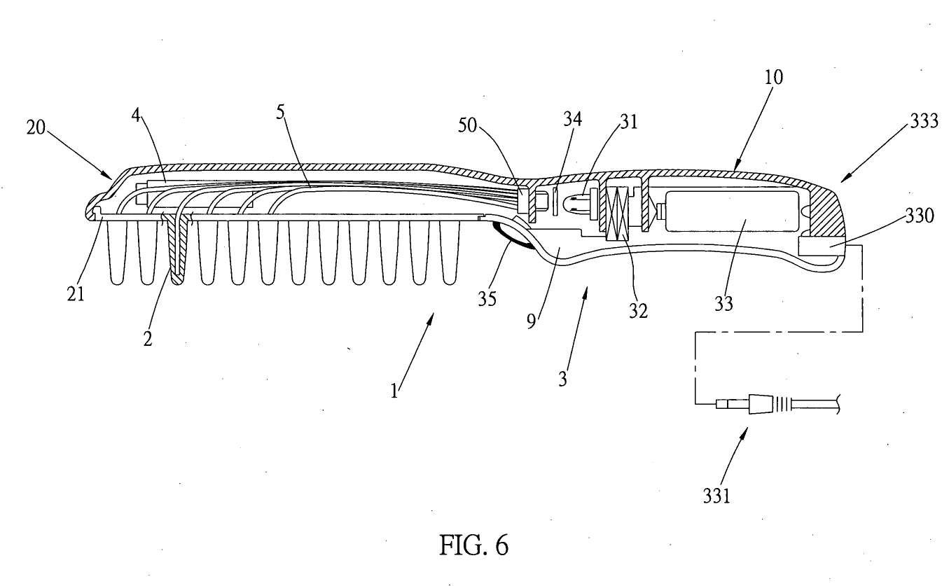

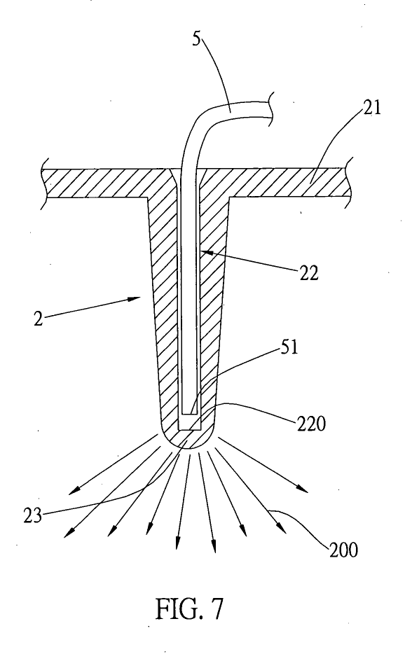

Referring to FIGS. 6 and 7, which show another embodiment of transmitting the light rays by the aforementioned light guide 23 that adopts a structural assembly whereby optical fibers 5 are connected to comb teeth 2. The light generator 31 emits light rays, which are then received and transmitted by a coupling end 50 that gathers together the optical fibers 5. Light wavelengths emitted by the light guide 31 are filtered by means of a light wave converter component 34 to form required wavelength or different forms of colored light rays.

The vibration wave device 4 having vibrational energy is installed within the compartment 9 of the comb head 20. Referring again to FIG. 7, wherein the function of the optical fibers 5 is to transmit light waves, and ends of the optical fibers 5 are light-transmitting ends 51. The comb teeth 2 are supported by the base 21, and an interior of each of the comb teeth 2 forms a passageway 22 that enables axial disposal of the optic fibers 5 therein. A lower end of the passageway 22 forms an incident light surface 220, from which the light rays emitted from the light-transmitting ends 51 are transmitted outward. Light guides formed by the comb teeth 2 are fabricated from transparent material, thereby enabling the light rays emitted from the light-transmitting ends 51 to form points of light 200.

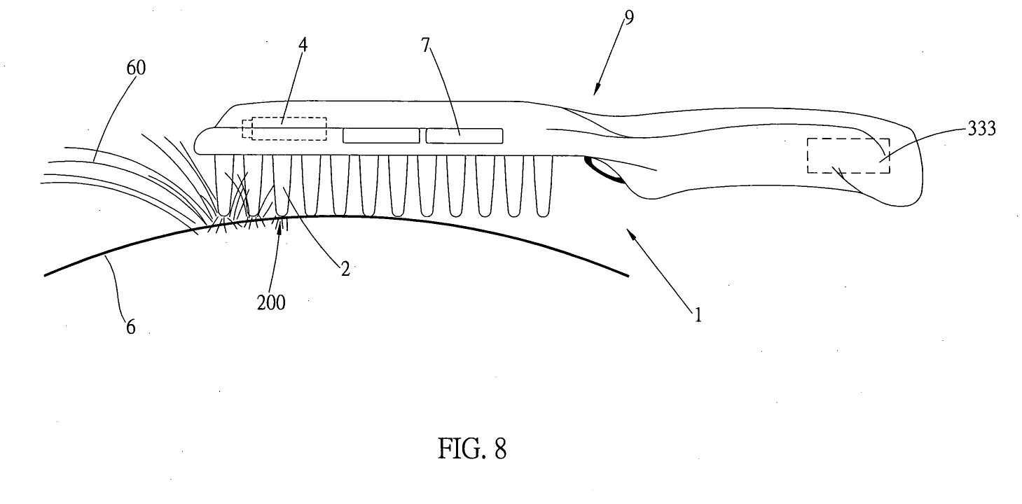

Referring to FIG. 8, which shows the comb teeth 2 being used to comb hair 60, wherein the light-transmitting ends 51 and ends of the light guide 23 press close to the scalp 6, and the points of light 200 formed act directly on the scalp 6, while space between each of the comb teeth 2 guide strands of the hair 60 to achieve a combing effect. During the course of comb therapy, the vibration wave device 4 having vibrational energy or a thermal generator 7 can be simultaneously actuated. The vibrational energy generated by the vibration wave device 4 is transmitted through the comb teeth 2 and used to directly act on the scalp 6, thereby producing a vibration wave massage effect on the scalp 6, or the thermal generator 7 directly emits thermal radiation waves that dry and sterilize the hair or have a hot compress effect on the scalp 6.

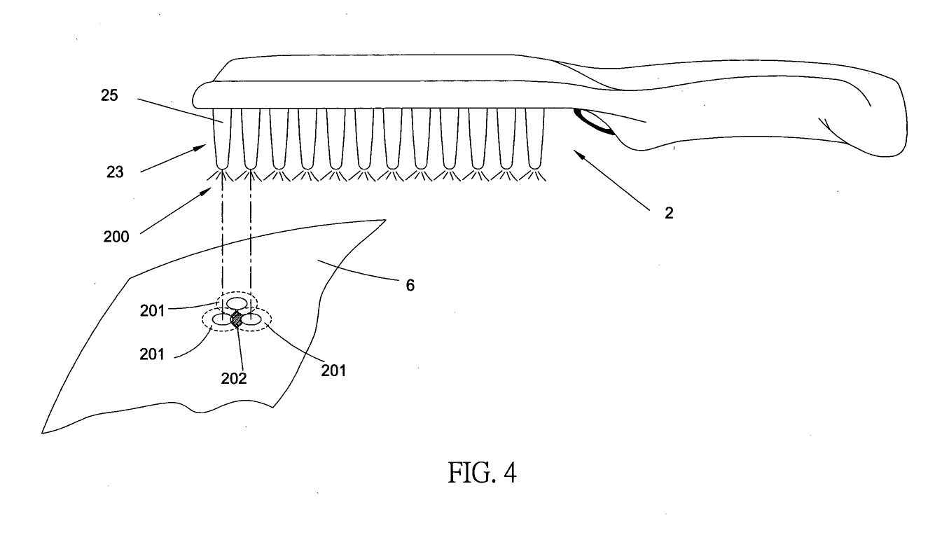

Referring to FIG. 4, which depicts an area of the scalp 6 irradiated by the light rays, wherein, the plurality of guide pins 25 of the comb teeth 2 are able to respectively form beams of light 201 on the surface of the scalp 6 using the areas of light formed by the points of light 200 from the light rays. Because the spaces between the plurality of guide pins 25 are arranged in an alternating configuration, thus, crossover areas 202 are formed between the beams of light 201, and the crossover areas 202 mutually connect to enable each of the beams of light 201 produced by the points of light 200 to intersect and form an integrated light transmitting surface that irradiates the surface of the scalp 6. Apart from the aforementioned intersecting arrangement of the adjacent light beams 201 that achieves an integrated light transmitting surface, moreover, variation in line of movement of the comb 1 when combing can be used to effect mutual light irradiation along different point positions of the scalp 6.

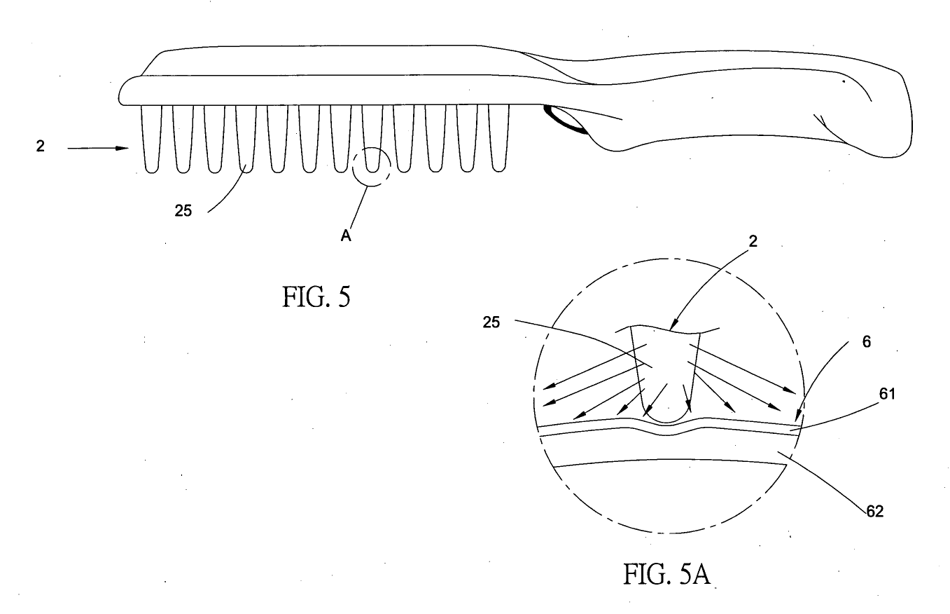

Referring to again to FIG. 5 and FIG. 5A, a lower interface of the light guide 23 formed by the ends of the plurality of guide pins 25 of the comb teeth 2 is circular arc-shaped, which presses on the epidermal layer of the scalp 6 during the course of combing, and the pressure penetrates deeply dermis tissue 62, thereby forming a stronger mechanical massage force. The circular arch-shape of the light guide 23 can prevent scuffing of the scalp 6.

Referring to FIG. 3, the present invention is further able to provide an extended massage area, whereby at least more than one massage knob 8 is disposed in the comb head 20 of the lower shell 12 of the comb 1, and because the form and structure of the massage knobs 8 is relatively larger than that of the comb teeth 2, thus, a corresponding relatively extended massage area is provided. A hand of a user operates the comb 1 to cause the massage knobs 8 to affect a pressing massage on the scalp of the user, or vibration waves can be used to further assist in producing a massage effect.

Referring again to FIG. 1, a male joint member 81 is affixed to a side of each of the massage knobs 8, and a movable joint method can be adopted to mutually join the male joint members 81 with female joint members 82 of the lower shell 12. The massage knobs 8 can be fabricated from different material or formed in different shapes to enable the user to replace the massage knobs 8 according to different needs or preferences. Moreover, the massage knobs 8 and the lower shell 12 can be manufactured as a single integrated body having external appearance similar to the joined state depicted in FIG. 3. Furthermore, apart from fabricating the massage knobs 8 from hard material, flexible material can also be used to counteract excessively intensive massage and present the scalp with a moderate touch. The massage knobs 8 can also be designed with light transmittance (not shown in the drawings), thereby enabling light rays emitted by the light stimulation device 3 within the compartment 9 to irradiate the scalp.

Referring again to FIG. 1, the power supply device 333 is disposed in a handle 10 of the upper shell 11 of the comb 1 of the present invention, and the electric sources 33 are disposed within an embodiment of the power supply device 333. The electric sources 33 use batteries 332 to supply electric power, and a battery cover 111 is used to cover and seal the batteries 332 within the handle 10.

An end of the handle 10 of the upper shell 11 is provided with a through hole 15 and a screw 14, wherein the screw 14 penetrates the through hole 15 and screws tight into a corresponding screw hole 13 defined in the lower shell 12. Furthermore, an end of the comb head 20 and two central side positions of the upper shell 11 and the lower shell 12 are provided with a plurality of mutually corresponding male and female tenons 16. The upper shell 11 and the lower shell 12 are joined together by means of the male and female tenons 16, thereby sealing the light guide 23, the light stimulation device 3 and the vibration wave device 4 within the compartment 9 formed between the upper shell 11 and the lower shell 12. A key-press hole 356 is defined in a top portion of the battery cover 111 of the handle 10 of the upper shell 11. When the upper shell 11 and the lower shell 12 are fastened together, a key-press 355 is securely disposed within the key-press hole 356.

Referring again to FIGS. 2 and 3, which show elevational views of the assembled present invention depicting the guide pins 25 of the comb teeth 2 penetrating the guide holes 24 and fixed on outer portions of the comb head 20 of the upper shell 11. After the upper shell 11 and the lower shell 12 are fastened together, the key-press 355 penetrates the key-press hole 356 and is fixed on an outer portion of the upper shell 11. The massage knobs 8 are fixed to an outer portion of the comb head 20 through mutual joining of the male joint members 81 and the female joint members 82 of the lower shell 12. When wanting to use the comb 1, the key-press 355 is pressed to actuate a switch 35 to supply electricity to the power supply device 333 (see FIG. 1), whereupon the comb 1 can be operated according to needs.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A light guide comb comprising an upper shell, a lower shell, a compartment, a light stimulation device and a light guide, wherein the upper shell and the lower shell are mutually joined to form the compartment, thereby enabling the light stimulation device to be disposed therein; a plurality of guide pins configured on the light guide; light rays emitted by the light stimulation device through the guide pins and are transmitted outwardly therefrom.

2. The light guide comb according to claims 1, wherein a plurality of guide holes are defined in the upper shell, position of which are such to correspond to a plurality of guide pins configured on the light guide; the plurality of guide pins penetrate the guide holes, thereby mutually joining each other together.

3. The light guide comb according to claims 1, wherein the light guide comprises at least one optical fiber, which are assembled in the light guide means of axial disposition; light rays emitted by the light stimulation device are propagated through the optical fibers, penetrate by way of the plurality of guide pins configured in the light guide, and are transmitted outward therefrom.

4. The light guide comb according to claim 3, wherein the guide pins are also defined as a plurality of comb teeth; the plurality of comb teeth are supported by a base, and an interior of each of the comb teeth forms a passageway that enables axial disposal of the optic fibers therein.

5. The light guide comb according to claim 4, wherein the plurality of comb teeth are fabricated from transparent material.

6. The light guide comb according to claims 1, wherein the plurality of guide pins are arranged in an alternating configuration, thereby forming crossover areas, enabling each of the beams of light to intersect and form an integrated light transmitting surface.

7. The light guide comb according to claim 1, wherein the upper shell and the lower shell are configured with corresponding male and female tenons that are used to mutually fasten together the upper shell and the lower shell.

8. The light guide comb according to claim 1, wherein the light guide and the plurality of guide pins of the light guide are fabricated from transparent material.

9. The light guide comb according to claim 1, wherein the light stimulation device further comprises at least one light generator, a power supply device and a switch.

10. The light guide comb according to claim 1, wherein the light stimulation device further comprises at least one drive circuit, which is used to enable the light stimulation device to emit light rays having specific wavelength.

11. The light guide comb according to claim 10, wherein the light rays having specific wavelength comprises one type of light ray from the following light rays: infrared rays, far-infrared rays, pulse light and laser light.

12. The light guide comb according to claim 1, wherein the light stimulation device further comprises a wavelength converter component that enables the transmitted light to produce different forms of colored light rays.

13. The light guide comb according to claim 9, wherein the light generator is a light-emitting diode (LED).

14. The light guide comb according to claim 9, wherein the light generator is a red light-emitting diode (LED).

15. The light guide comb according to claim 1, wherein the compartment is configured with a vibration wave device.

16. The light guide comb according to claim 1, wherein the compartment is configured with a thermal generator.

17. The light guide comb according to claim 1, wherein the power supply device includes alternating current or direct current.

18. The light guide comb according to claim 1, wherein at least more than one massage knob is outwardly affixed to the lower shell, thereby forming a relatively larger massage surface area.

19. The light guide comb according to claim 18, wherein a movable method is used to affix the massage knobs to the lower shell.

20. The light guide comb according to claim 18, wherein the massage knobs have a light transmittance property to enable achieving a light transmitting function.
